(19) United States
(12) Patent Application Publication
(10) Pub. No.: US 2015/0161728 A1
(43) Pub. Date: Jun. 11, 2015

(54) SYSTEM FOR DETERMINING HS COMMODITY CLASSIFICATION CODE

(71) Applicant: KOREA TRADE NETWORK, Seoul (KR)

(72) Inventor: Byung Jun SONG, Anyang-si (KR)

(73) Assignee: KOREA TRADE NETWORK, Seoul (KR)

(21) Appl. No.: 14/148,862

(22) Filed: Jan. 7, 2014

(30) Foreign Application Priority Data
Dec. 10, 2013 (KR) 10-2013-0153488

(51) Int. Cl. G06Q 40/04; G06F 17/30

(52) U.S. Cl. CPC G06Q 40/04; G06F 17/30598

(57) ABSTRACT

The present invention relates to a HS commodity classification code determination system including: an interface processing unit for providing a selective interface for inputting commodity information and providing an interface selected by a user, a database for storing information on a HS commodity classification code corresponding to the commodity information, and a HS commodity classification code determination unit for determining a HS commodity classification code corresponding to the commodity information by searching the database based on the commodity information input from the user through the interface.

### BACKGROUND OF THE INVENTION

1. Field of the Invention

The present invention relates to a system for determining a HS commodity classification code, and more specifically, to a system for automatically determining a HS commodity classification code by conducting a variety of inferences based on information input from a user.

2. Background of the Related Art

HS commodity classification is classifying a variety of products traded worldwide into one HS commodity classification code on the basis of the Harmonized Commodity Description and Coding System (Harmonized System in short or HS) enacted by the World Customs Organization (WCO), and participating countries performs HS commodity classification tasks according to a rule established in the HS system on the basis of the International Convention on the Harmonized Commodity Description and Coding System (HS Convention).

Since a tariff rate applied to each corresponding HS commodity classification code is previously determined to impose a tariff on an imported product, a duty amount to be paid is determined only after a correct HS commodity classification is performed. Particularly, since a different HS commodity classification code is applied to a case of having a similar function with a different form, to a case of having a similar form with a different function, or depending on whether a commodity is a part of general use or a part of dedicated use, it is important to correctly classify a HS commodity at the time of import declaration to pay a correct amount of tariff.

A HS commodity classification code is a classification code assigned to each imported or exported product based on the HS convention, which is a code commonly used worldwide up to the sixth digit, and the digits from the seventh position up to the tenth digit may be used in each country by subdividing the digits within the range of 6-digit subheadings. In Korea, a 10-digit code is used, and this is referred to as HS of Korea (HSK).

Describing the structure of the HS commodity classification code with an example, in a 10-digit HSK of 0102.90-10000,

01 (Chapter) is a chapter of first two digits for classifying living creatures,

0102 (Heading) is a heading of first four digits for classifying a cow,

0102.09 (Subheading) is a subheading of first five or six digits for classifying other kinds of cows, and

0102.90-1000 is a 10-digit code classifying a ^{┌}Milk Cow_{┘}. Each country may use the digits grater than the sixth digit by subdividing the digits within a range determined by the six digits. Korea uses ten digits by subdividing the last four digits.

A process of finding a HS commodity classification code corresponding to a specific product is referred to as a commodity classification, and correctly classifying a specific product according to the HS commodity classification codes having a hierarchical structure is an extremely difficult problem in reality. It is since that although the HS commodity classification is basically accomplished according to general rules of HS commodity classification of the HS convention enacted by the Customs Cooperation Council (CCC), a HS commodity classification code is not simply determined according to the type of a product, but may vary based the major characteristics, components, usages, materials or other various factors of the product.

When a specific product is imported and passes a customs clearance based on an erroneous commodity classification in customs law and it is proven thereafter that a wrong HS commodity classification code is applied, an importer (a taxpayer) bears economical burdens such as a deferred tax collection, an additional tax and the like due to the error made in the course of determining a HS commodity classification. Accordingly, although it is necessary to correctly classify a product to have a correct HS commodity classification code, HS commodity classification is difficult as described above.

### SUMMARY OF THE INVENTION

Therefore, the present invention has been made in view of the above problems, and it is an object of the present invention to easily and automatically determine a HS commodity classification code needed for import or export of a specific product.

Particularly, another object of the present invention is to determine a HS commodity classification code suitable for a variety of situations by determining the HS commodity classification code based on prior or similar cases.

Furthermore, another object of the present invention is to enhance accuracy of the HS commodity classification by determining a HS commodity classification code based on various kinds of information compared to the prior cases.

To accomplish the above objects, according to one aspect of the present invention, there is provided a system for determining a HS commodity classification code including: an interface processing unit for providing a selective interface for inputting commodity information and providing an interface selected by a user, a database for storing information on a HS commodity classification code corresponding to the commodity information, and a HS commodity classification code determination unit for determining a HS commodity classification code corresponding to the commodity information by searching the database based on the commodity information input from the user through the interface, and at this point, at least any one of general rules for commodity classification, rules for inclusion/exclusion of commodity classification, definitions of commodities, essential specifications for commodity classification, and a commodity classification system is matched to the commodity information or the HS commodity classification code and stored in the database, in addition to HS commodity classification codes specified in a Harmonized System, and the HS commodity classification code determination unit includes a keyword matching module for matching the input commodity information to commodity information stored in the database, and a HS commodity classification code determination module for determining a HS commodity classification code corresponding to the commodity information determined by the keyword matching module, and the HS commodity classification code determination module reflects at least any one of the general rules for commodity classification, the rules for inclusion/exclusion of commodity classification, the definitions of commodities, the essential specifications for commodity classification, and the commodity classification system matched to the determined commodity information when the HS commodity classification code is determined.

In an embodiment of the present invention, the interface processing unit provides an element-specific determination type interface for providing the user with import or export product HS commodity classification code characteristics of an industry to which a commodity desired to be classified by the user belongs, and at this point, the HS commodity classification code determination unit searches for the import or export product HS commodity classification code characteristics of each industry from the database, provides the import or export product HS commodity classification code characteristics to the user, and determines a HS commodity classification code corresponding to an import or export product HS commodity classification code characteristic selected by the user.

In another embodiment of the present invention, the interface processing unit provides a step-specific determination type interface for providing an essential input value of each determination step of an industry to which a commodity desired to be classified by the user belongs, and at this point, the HS commodity classification code determination unit determines the HS commodity classification code by narrowing a range of the HS commodity classification code in each step in correspondence to the essential input value of each determination step input from the user.

In another embodiment of the present invention, the database includes a first storage unit and a second storage unit, and the first storage unit stores at least any one of general rules for commodity classification, rules for inclusion/exclusion of commodity classification, definitions of commodities, essential specifications for commodity classification and a commodity classification system matching to the commodity information, in addition to the HS commodity classification codes specified in the Harmonized System, and the second storage unit matches and accumulatively stores commodity information and a HS commodity classification code respectively inputted and determined when commodity classification is determined in a past.

At this point, the interface processing unit provides import or export product HS commodity classification code characteristics of an industry to which a commodity desired to be classified by the user belongs and provides a case-specific determination type interface for inputting additional information by the user, and the HS commodity classification code determination unit primarily provides the HS commodity classification codes accumulatively stored in the second storage unit based on the import or export product HS commodity classification code characteristics and selects a HS commodity classification code among the primarily provided HS commodity classification codes in correspondence to the additional information input from the user.

On the other hand, the HS commodity classification code determination unit determines keywords of each HS commodity classification code classified and stored in the first storage unit based on a commodity classification principle and provides the keywords to the user, searches the second storage unit to determine whether or not there exists a case of determining a HS commodity classification code matching to commodity information input or selected by the user in correspondence to the keywords of each HS commodity classification code, provides the user with a case of determining a HS commodity classification code if there exists a case of determining the HS commodity classification code, and determines a HS commodity classification code based on a case selected by the user, and if a case of determining a HS commodity classification code does not exist in the second storage unit, the HS commodity classification code determination unit applies an individual element HS commodity classification code inference for separately searching for each of the keywords of each HS commodity classification code and inferring a HS commodity classification code by applying a heuristic algorithm and a compound element HS inference for integrally searching for entire keywords of each HS commodity classification code and inferring a HS commodity classification code by applying a heuristic algorithm, selects, based on a genetic algorithm, a simulation model for determining a HS commodity classification code based on a result of the applied HS inference, and determines a HS commodity classification code by applying the selected simulation model.

In another embodiment of the present invention, a result of determining a HS commodity classification code by the HS commodity classification code determination unit is additionally stored in the second storage unit as a case of determining a HS commodity classification code.

Meanwhile, at least one of a criterion for determining commodity classification, a criterion for determining a country of origin for each FTA, a conventional tariff rate and a case of determining commodity classification is matched to a HS commodity classification code and stored in the database, and the HS commodity classification code determination unit also provides at least any one of the criterion for determining commodity classification, the criterion for determining a country of origin for each FTA, the conventional tariff rate and the case of determining commodity classification when the HS commodity classification code is determined.

### BRIEF DESCRIPTION OF THE DRAWINGS

FIG. 1 a block diagram showing the configuration of a HS commodity classification code determination system of the present invention.

FIG. 2 a block diagram showing the configuration of a HS commodity classification code determination unit in the HS commodity classification code determination system of the present invention.

FIG. 3 shows a table summarizing examples of various kinds of information matched to a HS commodity classification code and stored in a database.

FIG. 4 a view showing an example of a user interface provided by an interface processing unit of the present invention.

FIG. 5 a flowchart illustrating a mechanism of determining a HS commodity classification code by the HS commodity classification code determination unit according to an embodiment of the present invention.

### DETAILED DESCRIPTION OF THE PREFERRED EMBODIMENT

The preferred embodiments of the invention will be hereafter described in detail with reference to the accompanying drawings.

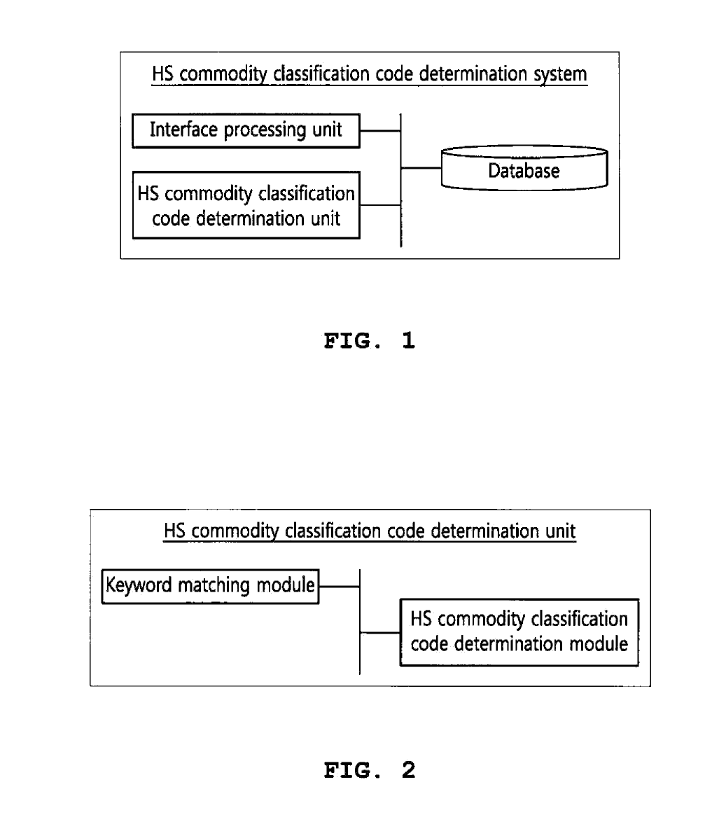

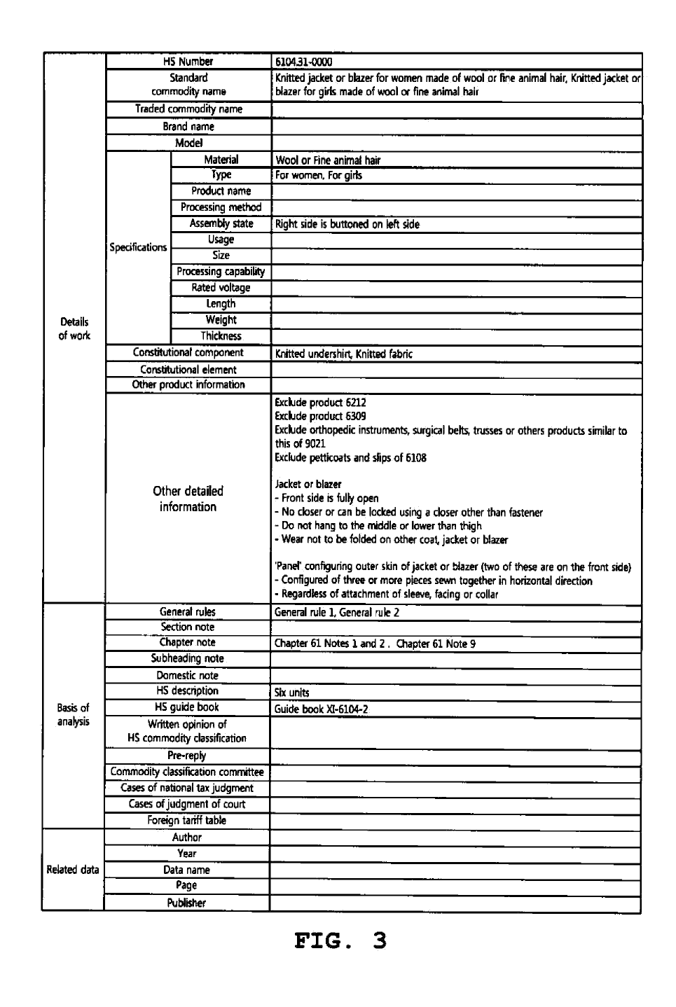

FIG. 1 a block diagram showing the configuration of a HS commodity classification code determination system of the present invention.

The HS commodity classification code determination system of the present invention basically includes an interface processing unit for providing a selective interface for inputting commodity information and providing an interface selected by user, a database for storing information on a HS commodity classification code corresponding to the commodity information, and a HS commodity classification code determination unit for determining a HS commodity classification code corresponding to the commodity information by searching the database based on the commodity information input from the user through the interface, and at this point, at least any one of general rules for commodity classification, rules for inclusion/exclusion of commodity classification, definitions of commodities, essential specifications for commodity classification, and a commodity classification system is matched to the commodity information or the HS commodity classification code and stored in the database, in addition to HS commodity classification codes specified in a Harmonized System, and the HS commodity classification code determination unit includes a keyword matching module for matching the input commodity information to commodity information stored in the database, and a HS commodity classification code determination module for determining a HS commodity classification code corresponding to the commodity information determined by the keyword matching module, and the HS commodity classification code determination module reflects at least any one of the general rules for commodity classification, the rules for inclusion/exclusion of commodity classification, the definitions of commodities, the essential specifications for commodity classification, and the commodity classification system matched to the determined commodity information when the HS commodity classification code is determined.

The interface processing unit provides a user with a method for determining a HS commodity classification code, provides an interface according to selection of the user, and transfers information input through the provided interface to the HS commodity classification code determination unit so that data processing for determining a commodity code may be progressed.

The database stores information on the HS commodity classification code corresponding to the commodity information. The information stored in the database is not simply one-to-one matching a specific commodity or specific commodity information to a HS commodity classification code, but the information is stored in the database in the form of a kind of m-to-n matching in which matching between a specific commodity and a HS commodity classification code varies according to a combination of the commodity information or according to a situation, characteristics of the commodity information and related rules in association with the general rules for commodity classification, rules for inclusion/exclusion of commodity classification, definitions of commodities, essential specifications for commodity classification, and a commodity classification system which will be described below.

The HS commodity classification code determination unit is a configuration for processing an operation to determine a HS commodity classification code matching to commodity information based on the commodity information input according to the interface selected by the user or proposed to the user and determining a HS commodity classification code corresponding to the commodity information by searching the database. A detailed method of determining a HS commodity classification code by the HS commodity classification code determination unit using the input information is described below.

The database of the present invention stores at least any one of general rules for commodity classification, rules for inclusion/exclusion of commodity classification, definitions of commodities, essential specifications for commodity classification and a commodity classification system matching to the commodity information or the HS commodity classification code, in addition to the HS commodity classification codes specified in the Harmonized System. Therefore, a commodity may be classified more correctly by reflecting the above information when the commodity is classified using the commodity information input from the user.

FIG. 3 summarizes an example of information matched and stored in the database as a table.

Referring to FIG. 3, various kinds of information matching to the HS commodity classification code 6104.31-0000 are shown. A standard commodity name is a “a knitted jacket or blazer for women made of wool or fine animal hair, and a knitted jacket or blazer for girls made of wool or fine animal hair” specified in the HSK, and detailed attributes of an item such as a material, type, an assembly state or constitutional components are stored. Accordingly, if commodity information input from the user includes information such as wool, for girls, knitted fabrics or the like, the HS commodity classification code 6104.31-0000 may also be a candidate group of the HS commodity classification code of the corresponding commodity.

In addition to this, in the present invention, information on the general rules for commodity classification, rules for inclusion/exclusion of commodity classification and the like is also matched to the HS commodity classification code and stored in the database. In the example of the HS commodity classification code 6104.31-0000 shown in FIG. 3, products of 6212 and 6309 are excluded, and orthopedic instruments, surgical belts, trusses or others products similar to these of 9021 and petticoats and slips of 6108 are excluded. That is, a specific candidate group may be excluded or selected from various HS commodity classification code candidate groups determined according to the input commodity information by reflecting the rules for inclusion/exclusion of commodity classification.

Conventionally, a method of selecting a category of a specific product one by one from an upper category to a lower category of the HS commodity classification codes constructed in a hierarchical structure is used to classify a specific product according to the HS commodity classification codes. That is, a chapter to which the specific product belongs is determined, and then a heading and a subheading to which the specific product belongs are confirmed one by one in the entire list to classify the product. However, as described above, since the commodity classification may vary according to properties, major characteristics, components, usages, materials or the like for even the same product, the conventional method has a problem in that a product may not be classified correctly. Furthermore, if a wrong category is selected in the process, for example, if a heading is wrongly selected although a chapter correctly selected, one of improper subheadings has to be selected.

However, in the present invention, since a HS commodity classification code is determined by matching the commodity information to the information stored in the database according to a variety of options, a commodity category can be determined to be appropriate to the properties, major characteristics, components, usages, materials or the like of the product compared with a conventional method of classifying a product based only on the HSK.

The interface processing unit of the present invention allows a user to select an interface for inputting commodity information and provides an interface selected by the user, and thus a HS commodity classification code may be determined in a variety of methods.

As an embodiment thereof, the interface processing unit of the present invention provides an element-specific determination type interface for providing a user with import or export product HS commodity classification code characteristics of an industry to which a commodity desired to be classified by the user belongs.

In the present invention, the HS commodity classification code determination unit searches for the import or export product HS commodity classification code characteristics of each industry from the database, provides the import or export product HS commodity classification code characteristics to the user, and determines a HS commodity classification code corresponding to an import or export product HS commodity classification code characteristic selected by the user.

According to the embodiment, although a user does not previously grasp detailed characteristics of a product desired to be classified, the user may be provided with HS commodity classification code features of an industry to which the product belongs and classify the commodity of the product according to a method of selecting a characteristic identical or similar to that of the corresponding product within the received HS commodity classification code features.

Meanwhile, in another embodiment of the present invention, the interface processing unit provides a step-specific determination type interface for providing an essential input value of each determination step of an industry to which a commodity desired to be classified by the user belongs.

At this point, the HS commodity classification code determination unit determines a HS commodity classification code by narrowing a range of the HS commodity classification code in each step in correspondence to the essential input value of each determination step input from a user.

In this embodiment, if any one (or a plurality) of essential input values is input from a user, the HS commodity classification code determination unit provides HS commodity classification codes corresponding to the input value. If the user inputs an essential input value of another item based on the primarily provided HS commodity classification codes, only HS commodity classification codes related to the newly input essential input value among the primarily provided HS commodity classification codes are provided. A HS commodity classification code is determined by performing this procedure several times in a kind of interactive method (the HS commodity classification code determination system repeats responding to a result corresponding to conditions presented by the user).

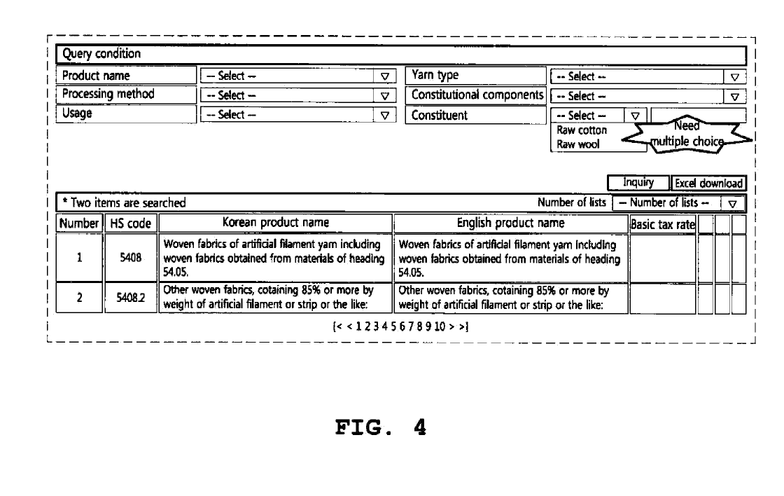

FIG. 4 shows an example of an interface according to this embodiment. Referring to FIG. 4, HS commodity classification codes are presented to the user according to an input condition, and the user may select a HS commodity classification code for classifying a commodity and corresponding to a specific product among the presented HS commodity classification codes. Although the example of FIG. 4 shows an almost final stage of the interactive user interface, the number of retrieved items may be further larger in an interface of an initial stage.

Meanwhile, in an embodiment of the present invention, the database includes a first storage unit and a second storage unit, and the first storage unit stores at least any one of general rules for commodity classification, rules for inclusion/exclusion of commodity classification, definitions of commodities, essential specifications for commodity classification and a commodity classification system matching to the commodity information, in addition to the HS commodity classification codes specified in the Harmonized System, and the second storage unit may match and accumulatively store commodity information and a HS commodity classification code respectively inputted and determined when classification of a commodity is determined in the past.

In this embodiment, the first storage unit and the second storage unit may be physically separate storage media, or may be a physical storage medium with separate storage areas. On the other hand, the storage units may be practically a storage medium, in which only types of stored information are distinguished.

In this embodiment, the database matches and accumulatively stores the commodity information and the HS commodity classification code respectively inputted and determined when classification of a commodity is determined in the past. If HS commodity classification of a specific product is determined according to the embodiment described above, a result thereof is stored so that the classification result of the past may be provided as an example when similar a condition, commodity information and the like are input in the future. That is, the past classification result is provided so that a HS commodity classification code may be determined based on a kind of Case Based Reasoning.

In another embodiment of the present invention, the interface processing unit may provide import or export product HS commodity classification code characteristics of an industry to which a commodity desired to be classified by a user belongs and provide a case-specific determination type interface for inputting additional information by the user. At this point, the HS commodity classification code determination unit may primarily provide the HS commodity classification codes accumulatively stored in the second storage unit based on the import or export product HS commodity classification code characteristics and select a HS commodity classification code among the primarily provided HS commodity classification codes in correspondence to the additional information input by the user.

In this embodiment, cases of the past HS commodity classification codes accumulatively stored in the second storage unit are not used as they are, but a HS commodity classification code is determined by reflecting characteristics of a currently classified product to the cases of the past.

When a HD commodity classification code is determined, there are lots of cases where characteristics, conditions, related regulations, import and export companies or the like are different, rather than a case of reclassifying a product having the same characteristics or conditions. That is, there are more cases where some of the content are changed than the cases the same as the past commodity classification cases accumulatively stored in the second storage unit.

In this embodiment, a HS commodity classification code similar to the past cases but reflecting a difference is selected considering such a situation. That is, a HS commodity classification code is determined by changing some of the information input from the past cases or adding information to the past cases and reflecting the change of addition of the information. According to this embodiment, it is possible to classify a commodity considering both the past cases and the characteristics of the current conditions.

In another embodiment of the present invention, the HS commodity classification code determination unit determines keywords of each HS commodity classification code classified and stored in the first storage unit based on a commodity classification principle and provides the keywords to a user, searches the second storage unit to determine whether or not there exists a case of determining a HS commodity classification code matching to commodity information input or selected by the user in correspondence to the keywords of each HS commodity classification code, provides the user with a case of determining a HS commodity classification code if there exists a case of determining the HS commodity classification code, and determines a HS commodity classification code based on a case selected by the user.

Meanwhile, if a case of determining a HS commodity classification code does not exist in the second storage unit, the HS commodity classification code determination unit applies an individual element HS commodity classification code inference for separately searching for each of the keywords of each HS commodity classification code and inferring a HS commodity classification code by applying a heuristic algorithm and a compound element HS inference for integrally searching for the entire keywords of each HS commodity classification code and inferring a HS commodity classification code by applying a heuristic algorithm, selects, based on a genetic algorithm, a simulation model for determining a HS commodity classification code based on a result of the applied HS inference, and determines a HS commodity classification code by applying the selected simulation model.

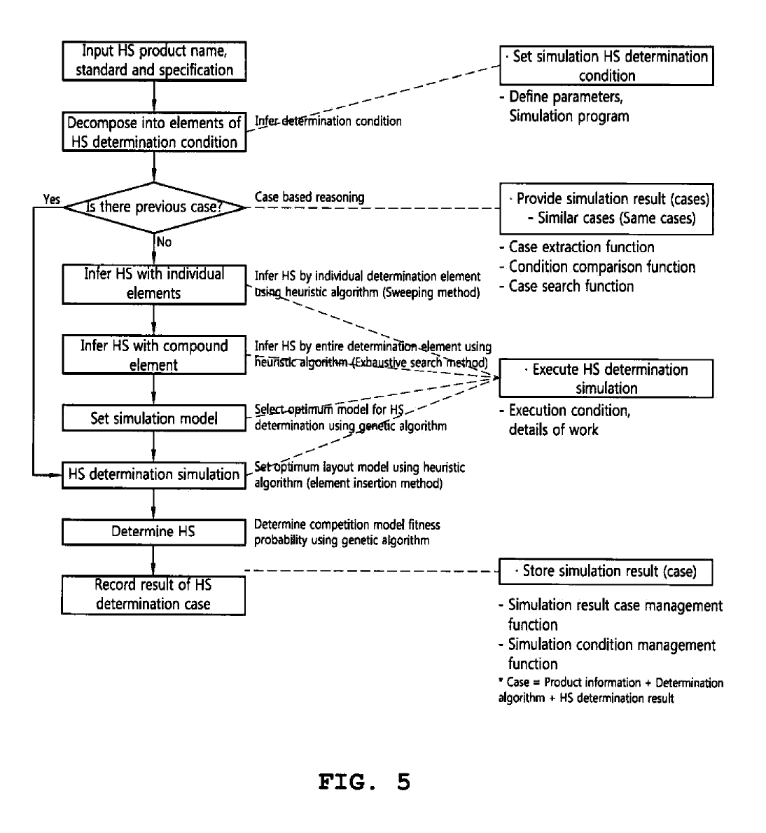

A mechanism for determining a HS commodity classification code by the HS commodity classification code determination unit according to this embodiment is shown in FIG. 5 in the form of a flowchart.

A sweeping method is particularly applied among the heuristic algorithms when the individual element HS commodity inference is applied, and an exhaustive search method is applied among the heuristic algorithms when the compound element HS commodity inference is applied.

The heuristic algorithm of the present invention does not use a ready-made formula, but means an art of good guessing or a procedure thereof which allows a user to discover and know a knowledge through an effort of minimizing trial and error of rule of thumb through an experience in a situation of incomplete information (for example, a good commodity classification expert determines a HS commodity classification code of a corresponding commodity through question and answer and fact data about some core contents. The expert determines a HS commodity classification code without a difficulty in the determination as much as possible based on a lot of experiences on commodity classification).

The heuristic algorithm is one of methods for solving a problem of determining a HS commodity classification code for an individual product, which is evolved as a problem of entire commodity classification. A sweeping method among the heuristic algorithm methods is a method of changing sequences or positions of estimations or search elements, an exhaustive search method is a method of sequentially applying estimations or search elements, and an element insertion method is a method of inserting elements in a basic model of estimation or search.

Meanwhile, in the process of applying a selected simulation model, a simulation is performed using the element insertion method among the heuristic algorithms, and a HS commodity classification code is determined by applying a result thereof to the genetic algorithm.

The genetic algorithm of the present invention is an evolution type operation technique imitating evolution of a creature like mutation or crossbreeding, in which an optimum answer is pursued by an algorithm which searches cases, estimations or the entire area of a search path in parallel. That is, the genetic algorithm is a simulated evolution search algorithm which is an approach for finding a solution x for optimizing a function Y=f(x) which gradually obtains better solutions by expressing possible solutions for solving the problem of determining a HS commodity classification number as a data structure of a determined form and then gradually modifying the solutions.

A result of determining a HS commodity classification code through the above-described algorithm is additionally stored in the second storage unit as a case of determining a HS commodity classification code. The additionally stored result may be applied when a HS commodity classification code is determined according to the previously mentioned Case Based Reasoning method.

Meanwhile, in an embodiment of the present invention, at least one of a criterion for determining commodity classification, a criterion for determining a country of origin for each FTA, a conventional tariff rate and a case of determining commodity classification is matched to a HS commodity classification code and stored in the database, and the HS commodity classification code determination unit also provides at least any one of the criterion for determining commodity classification, the criterion for determining a country of origin for each FTA, the conventional tariff rate and the case of determining commodity classification when the HS commodity classification code is determined. As a result, the present invention is not limited to simply providing a result of the HS commodity classification code in the form of a code, but various kinds of information to be considered in importing or exporting a corresponding product may be provided together.

According to the present invention, since basic information is input according to a user interface, a HS commodity classification code needed for importing and exporting a specific product may be automatically and easily determined.

Particularly, since the HS commodity classification code is determined based on previous or similar cases, a HS commodity classification code suitable for various situations may be determined.

Furthermore, since the HS commodity classification code is determined based on a variety of information compared with the prior art, correctness of the commodity classification may be enhanced, and utilization of a user may be enhanced by providing a variety of information related to a result of the commodity classification.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A HS commodity classification code determination system comprising:
an interface processing unit for providing a selective interface for inputting commodity information and providing an interface selected by a user;
a database for storing information on a HS commodity classification code corresponding to the commodity information; and
a HS commodity classification code determination unit for determining a HS commodity classification code corresponding to the commodity information by searching the database based on the commodity information input from the user through the interface, wherein
at least any one of general rules for commodity classification, rules for inclusion/exclusion of commodity classification, definitions of commodities, essential specifications for commodity classification, and a commodity classification system is matched to the commodity information or the HS commodity classification code and stored in the database, in addition to HS commodity classification codes specified in a Harmonized System, and
the HS commodity classification code determination unit includes
a keyword matching module for matching the input commodity information to commodity information stored in the database; and
a HS commodity classification code determination module for determining a HS commodity classification code corresponding to the commodity information determined by the keyword matching module; wherein
the HS commodity classification code determination module reflects at least any one of the general rules for commodity classification, the rules for inclusion/exclusion of commodity classification, the definitions of commodities, the essential specifications for commodity classification, and the commodity classification system matched to the determined commodity information when the HS commodity classification code is determined.

2. The system according to claim 1, wherein the interface processing unit provides an element-specific determination type interface for providing the user with import or export product HS commodity classification code characteristics of an industry to which a commodity desired to be classified by the user belongs.

3. The system according to claim 2, wherein the HS commodity classification code determination unit searches for the import or export product HS commodity classification code characteristics of each industry from the database, provides the import or export product HS commodity classification code characteristics to the user, and determines a HS commodity classification code corresponding to an import or export product HS commodity classification code characteristic selected by the user.

4. The system according to claim 1, wherein the interface processing unit provides a step-specific determination type interface for providing an essential input value of each determination step of an industry to which a commodity desired to be classified by the user belongs.

5. The system according to claim 4, wherein the HS commodity classification code determination unit determines the HS commodity classification code by narrowing a range of the HS commodity classification code in each step in correspondence to the essential input value of each determination step input from the user.

6. The system according to claim 1, wherein the database includes a first storage unit and a second storage unit, and the first storage unit stores at least any one of general rules for commodity classification, rules for inclusion/exclusion of commodity classification, definitions of commodities, essential specifications for commodity classification and a commodity classification system matching to the commodity information, in addition to the HS commodity classification codes specified in the Harmonized System, and the second storage unit matches and accumulatively stores commodity information and a HS commodity classification code respectively inputted and determined when commodity classification is determined in a past.

7. The system according to claim 6, wherein the interface processing unit provides import or export product HS commodity classification code characteristics of an industry to which commodity desired to be classified by the user belongs and provides a case-specific determination type interface for inputting additional information by the user.

8. The system according to claim 7, wherein the HS commodity classification code determination unit primarily provides the HS commodity classification codes accumulatively stored in the second storage unit based on the import or export product HS commodity classification code characteristics and selects a HS commodity classification code among the primarily provided HS commodity classification codes in correspondence to the additional information input from the user.

9. The system according to claim 6, wherein the HS commodity classification code determination unit determines keywords of each HS commodity classification code classified and stored in the first storage unit based on a commodity classification principle and provides the keywords to the user, searches the second storage unit to determine whether or not there exists a case of determining a HS commodity classification code matching to commodity information input or selected by the user in correspondence to the keywords of each HS commodity classification code, provides the user with a case of determining a HS commodity classification code if there exists a case of determining the HS commodity classification code, and determines a HS commodity classification code based on a case selected by the user.

10. The system according to claim 9, wherein if a case of determining a HS commodity classification code does not exist in the second storage unit, the HS commodity classification code determination unit applies
an individual element HS commodity classification code inference for separately searching for each of the keywords of each HS commodity classification code and inferring a HS commodity classification code by applying a heuristic algorithm and
a compound element HS inference for integrally searching for entire keywords of each HS commodity classification code and inferring a HS commodity classification code by applying a heuristic algorithm,
selects, based on a genetic algorithm, a simulation model for determining a HS commodity classification code based on a result of the applied HS inference, and determines a HS commodity classification code by applying the selected simulation model.

11. The system according to claim 10, wherein a result of determining a HS commodity classification code by the HS commodity classification code determination unit is additionally stored in the second storage unit as a case of determining a HS commodity classification code.

12. The system according to claim 1, wherein at least one of a criterion for determining commodity classification, a criterion for determining a country of origin for each FTA, a conventional tariff rate and a case of determining commodity classification is matched to a HS commodity classification code and stored in the database, and the HS commodity classification code determination unit also provides at least any one of the criterion for determining commodity classification, the criterion for determining a country of origin for each FTA, the conventional tariff rate and the case of determining commodity classification when the HS commodity classification code is determined.
